(19) United States
(12) Patent Application Publication
(10) Pub. No.: US 2006/0112733 A1
(43) Pub. Date: Jun. 1, 2006

(54) Equipment and method for manufacturing a glass preform

(75) Inventors: Tomohiro Ishihara, Yokohama-shi (JP); Tomomi Moriya, Yokohama-shi (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD.

(21) Appl. No.: 11/270,663

(22) Filed: Nov. 10, 2005

(30) Foreign Application Priority Data
Nov. 26, 2004 (JP) 2004-341678

(51) Int. Cl. C03B 37/012

(52) U.S. Cl. 65/427; 65/507

(57) ABSTRACT

Provide are safe equipment and method, in which gas leakage through junction part between a furnace muffle tube and a lid can be restrained, for manufacturing a high quality glass preform. The equipment for manufacturing a glass preform comprises (1) a furnace muffle tube in which a soot glass deposit body is placed, (2) a lid for sealing up an inlet-outlet opening of the furnace muffle tube, and (3) a heater for heating the soot glass deposit body. The method of producing a soot glass deposit body comprises steps of (1) placing a soot glass deposit body into a furnace muffle tube, (2) sealing up the inlet-outlet opening of the furnace muffle tube with a lid, (3) heating the soot glass deposit body so as to vitrify it into a transparent glass body. In these equipment and the method, the surface roughness in the respective junction surfaces of the furnace muffle tube and the lid is 1.0 μm or less, the flatness degree in the respective junction surfaces of the furnace muffle tube and the lid is 30 μm or less, and the load on the junction surface is equal to or more than 98 N.

### BACKGROUND OF THE INVENTION

1. Field of the Invention

The present invention relates to equipment and method for manufacturing a glass preform by dehydrating and consolidating a soot glass deposit body and thereby vitrifying it into transparent glass.

2. Description of the Background Art

In a known method of manufacturing a glass preform for an optical fiber, a soot glass deposit body is first produced and it is vitrified into transparent glass by dehydrating and consolidating it. In some cases, the glass preform is softened by heating and elongated so as to have a given outer diameter. Vapor phase axial deposition method (VAD method), Outside vapor phase deposition method (OVD method), etc. are known as methods for producing soot glass deposit bodies. In these methods, fine glass particles, which are produced by flame-hydrolysis from glass material gases such as SiCl₄ and GeCl₄, are deposited onto a starting glass rod so as to produce a soot glass deposit body.

For vitrifying a soot glass deposit body into transparent glass, the soot glass deposit body is put in a container made of quartz glass or graphite which has good airtightness and into which helium and chloric gases are introduced, for example, and the soot glass deposit body is heated at a high temperature of 1000° C. or higher. The container must be provided with a part which functions as a gateway for taking in a soot glass deposit body and taking out a transparent glass, and therefore, the container comprises a furnace muffle tube and a lid.

The furnace muffle tube and the lid are generally provided, at their respective junction part, with a flange to keep airtightness during dehydration and consolidation. The junction surfaces of the flanges are polished. However, sufficient airtightness cannot be obtained by merely joining the flange surfaces physically. Consequently, when heat-treatment is performed by introducing a helium gas and a chloric gas into the container, the gases which have been introduced may leak outside because of the pressure in the container, or the atmosphere may enter into the container.

For example, if the inside of the container is kept at a pressure lower than the outside pressure, the outside gas which enters into the container may increase and the impurities such as metallic ions and OH groups in the atmosphere may mix into a glass preform. If the inside of the container is kept at a pressure which is higher than the outside, the gas that leaks out from the container may increase. Thus, when a harmful chloric gas is used, it may have a bad influence on the human body, and when an inert gas of helium is used, it may make the atmosphere around the heating furnace to be short of oxygen. Also, the leak out of expensive helium results in much wastefulness.

Therefore, as Japanese Patent Application Publication Nos. 2002-211943 and 2004-115316 disclose, countermeasure for improving sealing up is performed by supplying a sealing gas to the junction surface of the furnace muffle tube and the lid. FIG. 2 is a schematic diagram of conventional equipment disclosed in Japanese Patent Application Publication No. 2004-115316 for manufacturing a glass preform. A container 1 is divided into at least two parts: a furnace muffle tube 2 and a lid 3, and the divided container parts are joined together with flange parts 2a and 3a provided therein. A gas introducing part 5 is provided at the lower side of the container 1, and a gas exhaust part 6 is provided at the upper side. Thus, a chloric gas, a helium gas, etc., which are necessary for dehydration and vitrification into transparent glass, are introduced into the container 1.

The lid 3 has a hole which is pierced through by a glass rod 8 which extends from the end of a soot glass deposit body 7. The upper end of the glass rod is connected to a support device (not illustrated in the figure). A suction device (not illustrated) is arranged near the hole, and the gas which leaks out from the hole is excluded by the suction device. A plurality of heaters 4 arranged around the outer peripheries of the container 1 heat the soot glass deposit body 7 stored in the container 1.

Two pressing members 9 having a concave groove 9a at the inside thereof are arranged in a manner enclosing the outer peripheries of flange parts 2a and 3a which connect the furnace muffle tube 2 and the lid 3. The pressing members 9 are installed with pre-determined pressing power with an air cylinder mechanism or the like so as not to break the furnace muffle tube with an excessive pressing power. The flange parts 2a and 3a are joined together by the wedge effect given from the top and the bottom by the concave grooves 9a formed inside the pressing members 9.

When the pressing members 9 are set at pre-determined positions, passages 9b are thereby generated between the outer surfaces of the flange parts 2a and 3a and the bottom walls of the concave grooves 9a. A sealing gas such as an inert gas supplied from a gas supply part is let through the passages 9b so as to be discharged. Thus, even if a gas leaks from a minute gap between the flange parts 2a and 3a, the leaking gas is discharged from the gas discharge part with the sealing gas supplied to the passages 9b. In this way, it is possible to completely prevent a gas in the container from leaking out or impurities from entering into the container through a joint part.

The problem of gas leakage through a junction part of the container can be solved by using a method disclosed in Japanese Patent Application Publication No. 2002-211943 or Japanese Patent Application Publication No. 2004-115316. However, it is expensive to provide necessary equipment which is comparatively large-scale since pressing members and an air cylinder mechanism for pressing the pressing members, the supply of sealing gas to the passages between the pressing members and the flanges, and the supply and discharge means for the sealing gas, etc. are needed. Therefore, it is needed to provide a simple method which can, without using such large-scale equipment, prevent a gas inside the container from leaking outside and impurities from entering into the container.

### SUMMARY OF THE INVENTION

An object of the present invention is to provide safe equipment and method, in which gas leakage in junction part between a furnace muffle tube and a lid can be restrained, for manufacturing a high quality glass preform.

To this end, equipment for manufacturing a glass preform by heating a soot glass deposit body and thereby vitrifying it into a transparent glass body comprises (1) a furnace muffle tube in which a soot glass deposit body is placed, (2) a lid for sealing up an inlet-outlet opening of the furnace muffle tube, and (3) a heater for heating the soot glass deposit body. In this equipment, the surface roughness in the respective junction surfaces of the furnace muffle tube and the lid is 1.0 μm or less, the flatness degree in the respective junction surfaces of the furnace muffle tube and the lid is 30 μm or less, and the load on the junction surface is equal to or more than 98 N.

Another aspect of the invention is a method in which a glass preform is produced via a soot glass deposit body and which comprises steps of (1) placing a soot glass deposit body into a furnace muffle tube, (2) sealing up the inlet-outlet opening of the furnace muffle tube with a lid, (3) heating the soot glass deposit body so as to vitrify it into a transparent glass body. In this method, the surface roughness in the respective junction surfaces of the furnace muffle tube and the lid is 1.0 μm or less, the flatness degree in the respective junction surfaces of the furnace muffle tube and the lid is 30 μm or less, and the load on the junction surface is equal to or more than 98 N.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram of equipment according to an embodiment of the present invention for manufacturing a glass preform;

FIG. 2 is a schematic diagram of conventional equipment for manufacturing a glass preform.

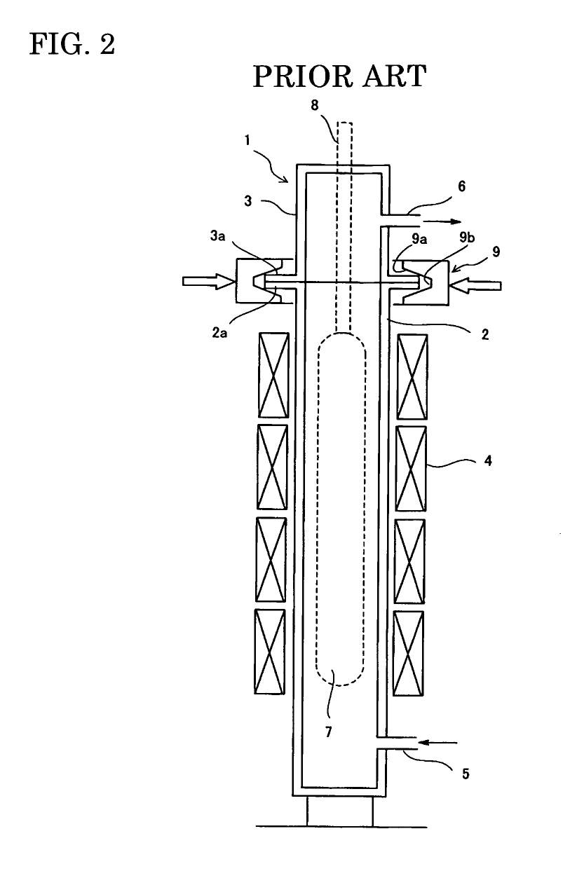

### DETAILED DESCRIPTION OF THE INVENTION

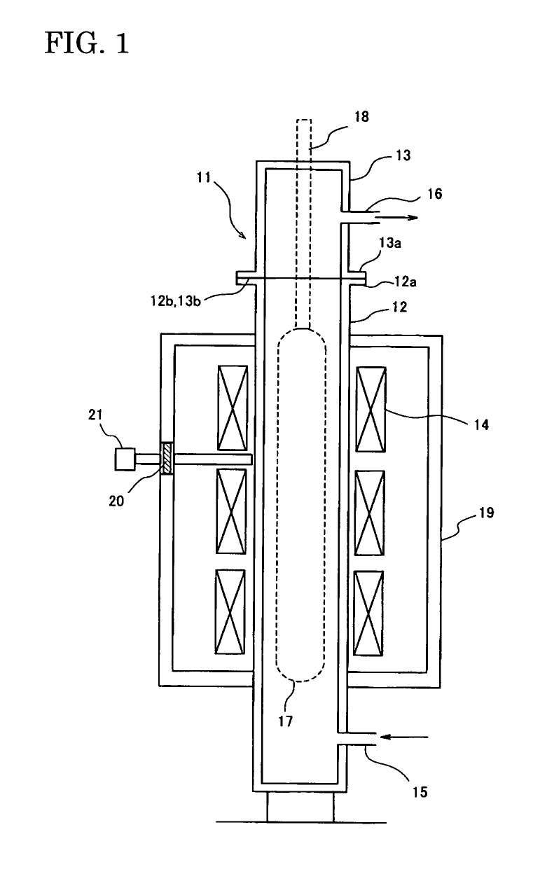

FIG. 1 is a schematic diagram of equipment according to an embodiment of the present invention for manufacturing a glass preform. The equipment of the embodiment for manufacturing a glass preform is capable of dehydrating and consolidating a soot glass deposit body and thereby vitrifying it into transparent glass. A furnace body used for dehydration/consolidation includes a container 11 which is made of graphite or quartz glass having excellent heat resistance and corrosion resistance and which is divided at least into two parts: a furnace muffle tube 12 and a lid 13. The junction part of the furnace muffle tube 12 and the lid 13 is provided with wide junction surfaces 12b and 13b, for example, flange parts 12a and 13a.

In the upper end of the lid 13, a hole is provided through which a glass rod 18 (a dummy rod+support rod) extending from the end of the soot glass deposit body 17 can be pierced in a turnable manner. A plurality of heaters 14 arranged around the outer peripheries of the container 11 heat the soot glass deposit body 17 which is stored in the container 11. As for the heaters, those of resistance heating type or induction heating type are applicable.

Heat insulators (not illustrated in the figure) are arranged outside the heaters 14, and the whole heating part is covered with the wall of a furnace body 19 so as to be protected. A gas introducing part 15 is provided at the lower part of the container 11 and a gas exhaust part 16 is provided at the upper part of the container 11 so that a chloric gas, a helium gas, etc. which are used for heat-treatment are introduced and are discharged. It is possible to provide the wall of the furnace body 19 with a monitoring window 20 through which the heating condition of the furnace muffle tube 12 can be monitored and the radiation thermometer 21 which can measure the temperature around the neighborhood of the furnace muffle tube.

The temperature in the neighborhood of the furnace muffle tube is controlled to be a predetermined temperature by adjusting electric current or voltage applied to the heaters so that the measured temperature in the neighborhood of the furnace muffle tube may become the predetermined value. More specifically, a graphite pipe is inserted into the furnace through the wall of the furnace in a manner such that the closed end of the pipe is located close to the vicinity of the furnace muffle tube and a radiation thermometer is inserted into the pipe from the open end thereof. The light emittance at the closed end of the pipe is measured with the radiation thermometer, and the measured temperature, which is regarded as the temperature around the furnace muffle tube, is adjusted by the electric current or voltage applied to the heater so that the temperature may become the predetermined value.

The methods of heating a soot glass deposit body 17 include a method in which heating is uniformly done with a heater 14 in a state where the axial position of the soot glass deposit body 17 is fixed at a given position, and a method in which heating conditions of a plurality of heaters 14 are controlled by switching the heaters so that the heating temperature is changed in an axial direction of the soot glass deposit body 17. In this case, the soot glass deposit body 17 may be turned so that the heating condition may circumferentially be equalized. In addition, there is a zone heating method in which the soot glass deposit body 17 or the heater 14 is caused to move in a relative movement. The present invention can be applied to any of these heating methods.

The respective junction surfaces 12b and 13b of the flange part 12a of the furnace muffle tube 12 and the flange part 13a of the lid 13 are polished, and the surface roughness of the respective junction surfaces is 1.0 μm or less, the flatness degree of the respective junction surfaces is 30 μm or less, and the load (lid weight) of junction surfaces 12b and 13b is 98 N (10 kgf) or more. Here, the term “surface roughness” as used in the present invention means an arithmetic average roughness of surface roughness as defined in JIS (B0601) and the term “flatness degree” as used in the present invention means the surface roughness as defined in JIS (B0610) and the flatness degree is measured with a thickness gauge inserted between a surface plate and a junction surface of a sample to be measured which is placed on the surface plate.

Considering the area of the junction surfaces 12b and 13b, the load of the junction surfaces can be converted into pressure. In the present embodiment, the inner and outer diameters of the flange parts are 350 mm and 450 mm, respectively. Therefore, the preferable range of the pressure on the junction surfaces 12b and 13b can be calculated to 1560 Pa or more.

A high quality glass preform can be safely manufactured by making the surface roughness of junction surfaces 12b and 13b of the furnace muffle tube 12 and the lid 13 equal to or less than 1.0 μm, the flatness degree of the junction surfaces 12b and 13b equal to or less than 30 μm, and the lid weight large and thereby enhancing junction degree between the junction surfaces 12b and 13b so that gas leakage from the junction surfaces as well as the entry of impurities from outside can be reduced more.

In a case where a desired weight cannot be obtained with the lid itself, a load may be added to increase the weight applied to the junction surfaces. Also, preferably the difference of the thermal expansion coefficient between the furnace muffle tube 12 and the lid 13 is 1×10⁻⁵/K or less.

Table I shows the transmission losses of optical fibers manufactured from glass preforms in the respective examples in which the glass preforms were manufactured, changing the surface roughness and flatness degree of the junction surfaces of the furnace muffle tube and the lid and the load applied on the junction surfaces in the above-mentioned equipment.

TABLE I

| | Surface | | | |
|---|---|---|---|---|
| | roughness | Flatness | Lid load | Loss |
| | μm | μm | N | dB/km |
| Example 1 | 0.1 | 10 | 294 | 0.30 |
| Example 2 | 0.5 | 10 | 294 | 0.41 |
| Example 3 | 1.0 | 10 | 294 | 0.52 |
| Comparative Example 1 | 1.1 | 10 | 294 | 0.73 |
| Comparative Example 2 | 1.5 | 10 | 294 | 1.04 |
| Example 4 | 0.1 | 10 | 196 | 0.40 |
| Example 5 | 0.1 | 10 | 98 | 0.50 |
| Comparative Example 3 | 0.1 | 10 | 88 | 0.75 |
| Comparative Example 4 | 0.1 | 10 | 49 | 0.92 |
| Example 6 | 0.1 | 20 | 294 | 0.41 |
| Example 7 | 0.1 | 30 | 294 | 0.52 |
| Comparative Example 5 | 0.1 | 31 | 294 | 0.71 |
| Comparative Example 6 | 0.1 | 50 | 294 | 0.90 |

For manufacturing a glass preform, first, a starting glass rod was prepared by welding a glass dummy rod to both ends of a core glass rod of 20 mm diameter having core/cladding regions. Then, a soot glass deposit body having an effective portion of 200 mm in outer diameter and 1000 mm in length was formed by the VAD method on the outer periphery of the starting glass rod. A glass preform was manufactured by dehydrating and consolidating the soot glass deposit body so as to vitrify it into transparent glass, using the equipment shown in FIG. 1 for manufacturing a glass preform.

The furnace muffle tube and the lid used were both made of quartz glass. The axial position of the soot glass deposit body was fixed in the container so as to uniformly be heated, and during the heat-treatment, the inside pressure of the container was controlled to be 100 Pa lower than that of outside the container. While the furnace muffle tube was heated, a mixed gas composed of 0.1 liters per minute of Cl₂ gas and 20 liters per minute of He gas was flowed simultaneously in the container, and the heating was stopped when the temperature of the furnace muffle tube was raised to 1000° C., and then the condition was kept for 3 hours. Thereafter, the inside temperature of the furnace muffle tube was increased to 1550° C., which was maintained for 2 hours. Subsequently, the glass preform which was vitrified into transparent glass was removed from inside the container and drawn into a single mode fiber having a glass outer diameter of 125 μm with another manufacturing equipment.

The degree of transmission loss α_{1.38} at a wavelength of 1.38 μm can be used as an index indicating the amount of the OH groups contained in the optical fiber. The existence of many OH groups in the optical fiber means the increase of the OH groups in the glass preform from which the optical fiber originates. Thus, it is assumed that during the heat treatment of the glass preform some amount of surrounding atmosphere has entered into the container through a gap between junction surfaces because of a poor sealing condition at the junction surfaces of the furnace muffle tube and the moisture in the atmosphere has mixed into the glass preform. Therefore, the quality of junction surfaces of the container can be evaluated by measuring α_{1.38} of an optical fiber made from a glass preform. In the present invention, transmission loss α_{1.38} below 0.7 dB/km or less, which can be regarded as no-problem in an actual use, is treated as good quality, and the transmission loss α_{1.38} exceeding 0.7 dB/km is treated as defective quality.

When the transmission losses α_{1.38} of optical fibers in Examples 1-3 and Comparative Examples 1 and 2 (in all of these examples the flatness degree was 10 μm, and lid load was 294 N) were compared, the loss exceeding 0.7 dB/km was caused in Comparative Examples 1 and 2 in which the surface roughness exceeded 1.0 μm and the optical fibers in the Comparative Examples 1 and 2 were treated as defective. On the other hand, in Examples 1-3 in which the surface roughness was equal to or less than 1.0 μm, the transmission loss α_{1.38} was within the range of good quality.

When the transmission losses α_{1.38} in Examples 1, 6, and 7 and Comparative Examples 5 and 6 (in all of these examples, the surface roughness was 0.1 μm, and the lid load was 294 N) were compared, the loss exceeding 0.7 dB/km was caused in Comparative Examples 5 and 6 in which the flatness degree exceeded 30 μm and the optical fibers in the Comparative Examples 5 and 6 were treated as defective. On the other hand, in Examples 1, 6, and 7 in which the flatness degree was equal to or less than 30 μm, the transmission loss α_{1.38} was within the range of good quality.

When the transmission losses α_{1.38} of the optical fibers in Examples 1, 4, and 5 and Comparative examples 3 and 4 (in all of these examples, the surface roughness was 0.1 μm, and the flatness degree was 10 μm) were compared, the loss exceeding 0.7 dB/km was caused in Comparative Examples 3 and 4 in which the lid load was less than 98 N, and accordingly the optical fibers in the Comparative Examples 3 and 4 were treated as defective. On the other hand, in Examples 1, 4, and 5 in which the lid load was equal to or more than 98 N, the transmission losses α_{1.38} were within the range of good quality.

Thus, when a glass preform is manufactured in a manner such that the surface roughness of junction surfaces of the furnace muffle tube and the lid is equal to or less than 1.0 μm, the flatness degree is equal to or less than 30 μm, and the lid load equal to or more than 98 N, the inflow of atmosphere through the junction surfaces can be restrained to a degree which does not matter in actual use. In the above-mentioned evaluation, the pressure in the container was lower than outside the container. However, in the case where the pressure in the container is higher than outside the container, the leak of gas through the junction surfaces of the furnace muffle tube and the lid can be considered to be the same as in the case of inflow, and the leak of gas can be effectively restrained.

A high quality glass preform can be manufactured according to the composition of the present invention by reducing gas leakage through the junction surfaces of the furnace muffle tube and the lid, enhancing safety in the work environment, and restraining outside impurities from entering inside. With the high quality glass preform, it is possible to produce an optical fiber having small transmission loss.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims. The entire disclosure of Japanese Patent Application No. 2004-341678 filed on Nov. 26, 2004 including specification, claims drawings and summary are incorporated herein by reference in its entirety.

What is claimed is:

1. Equipment for manufacturing a glass preform by heating a soot glass deposit body and thereby vitrifying it into a transparent glass body, comprising:
(1) a furnace muffle tube in which a soot glass deposit body is placed;
(2) a lid for sealing up an inlet-outlet opening of the furnace muffle tube; and
(3) a heater for heating soot glass deposit body,
wherein the surface roughness in the respective junction surfaces of the furnace muffle tube and the lid is 1.0 μm or less, the flatness degree in the respective junction surfaces of the furnace muffle tube and the lid is 30 μm or less, and the load on the junction surface is equal to or more than 98 N.

2. A method of manufacturing a glass preform via a soot glass deposit body, comprising the steps of:
(1) placing a soot glass deposit body in a furnace muffle tube;
(2) sealing up an inlet-outlet opening of the furnace muffle tube with a lid; and
(3) heating the soot glass deposit body so as to vitrify it into a transparent glass body,
wherein the surface roughness in the respective junction surfaces of the furnace muffle tube and the lid is 1.0 μm or less, the flatness degree in the respective junction surfaces of the furnace muffle tube and the lid is 30 μm or less, and the load on the junction surface is equal to or more than 98 N.
